(19) United States
(12) Patent Application Publication
(10) Pub. No.: US 2012/0215665 A1
(43) Pub. Date: Aug. 23, 2012

(54) METHOD AND SYSTEM FOR DYNAMIC WEB DISPLAY

(76) Inventor: John Marshall, Stoney Creek (CA)

(21) Appl. No.: 13/399,600

(22) Filed: Feb. 17, 2012

Related U.S. Application Data
(63) Continuation of application No. 10/926,974, filed on Aug. 27, 2004.
(60) Provisional application No. 60/497,915, filed on Aug. 27, 2003.

(51) Int. Cl. G06Q 30/00

(52) U.S. Cl. 705/27.1

(57) ABSTRACT

A system for transacting retrieval of real estate property listing(s) over an information network and dynamically transmitting the listing(s), in near or real time, to one or more banner(s) enabled with dynamic messaging technology residing on an ad server and the banner(s) are posted on one or more Internet urls, comprising a set of real estate property listings maintained in an inventory repository server. A target data set describing one or more such listings for at least one such agent compiled by the database module is retrieved from the an inventory repository server; the listings matching the target data set from the structured database are then identified and retrieved by the banner enabled with dynamic messaging technology and displayed within one or more banners residing on one or more publisher web sites.

### REFERENCE TO RELATED APPLICATIONS

This application is a continuation application of pending U.S. application Ser. No. 10/926,974, filed Aug. 27, 2004, which claims the benefit of U.S. provisional patent application No. 60/497,915 filed Aug. 27, 2003, entitled “Method and System for Dynamic Web Display,” the entire disclosures of which are incorporated herein by reference for all purposes.

### FIELD OF THE INVENTION

The present invention relates to a method and system for displaying classified and inventory-based listings within a browser-displayed banner using Flash technology on an electronic network.

### BACKGROUND OF THE INVENTION

The use of databases for storing information relating to classified and inventory-based information has become widely accepted. Not merely is its popularity due to its ability to provide information to professionals in the industry, but also its potential as a means of disseminating information quickly and widely by using other technologies. One such area of application relates to real estate property.

The information in a listing for a piece of property may include a number of elements, including its postal address, physical characteristics of the property including number and type of rooms, the realtor responsible for marketing the property, and images of the property such as photographs, videos, and even virtual tours.

All of these above information, or a substantial part thereof, may be provided to a person using the Internet, an extranet or an intranet, for display on a computer to the said person. The presented information may be static such as text or a photograph, or dynamic such a video stream; it may be not merely visual, but also multimedia in format.

### SUMMARY OF THE INVENTION

This invention provides for a system for dynamic web display at a browser on an electronic network of real estate data, comprising: a database containing a plurality of listings; an ad server with Flash banners enabled with dynamic messaging technology in electronic communication with the database using Flash™; a controller embedded within the browser for receiving user input and inventory data from the ad server; wherein a target data set for the real estate data is compiled in a data string describing one or more such listings for at least one agent by the inventory repository server; the target data set from the inventory repository server retrieved by the Flash banners is then displayed on at least one Flash banner residing on at least one publisher web sites and posted on at least one url's.

This invention also provides for a method for dynamic web display at a browser on an electronic network of real estate data, comprising the steps of: receiving a request at an inventory repository server for real estate data; compiling a target data set for the real estate data in a data string describing one or more listings for at least one agent by the inventory repository server in electronic communication with a database, and customized rendering instructions; retrieving the target data set from the inventory repository server by the Flash banner; and displaying the real estate data on at least one Flash banner residing on at least one publisher web sites.

This invention further provides for a system for transacting retrieval of real estate property listing(s) over an information network and dynamically transmitting the listing(s), in near or real time, to one or more Flash banner(s) enabled with dynamic messaging technology using Flash™ residing on an ad server and the Flash banner(s) are posted on one or more Internet urls, comprising: a set of real estate property listings is maintained in a structured database, each listing including a data record set describing property listing information organized according to individual real estate agent, the data record set containing all information comprising ad display duration time, publisher selection, campaign ID, campaign duration, listing details; an inventory repository server including a database module interfaced in a dynamic search session via a communications link connected over an information network, the database module maintaining both program code and data in a general purpose random access memory configured for both transient and persistent storage; and a target data set in a data string describing one or more such listings for at least one such agent compiled by the database module upon initiation of a session; the listings matching the target data set from the structured database being then identified and retrieved by the controller enabled with dynamic messaging technology and displayed on one or more Flash banners, residing on one or more publisher web sites and the Flash banners are posted on one or more url's upon termination of the session.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic depicting one embodiment of the system according to the invention.

FIGS. 2a-2c are line drawings from the perspective of a user of one embodiment of the invention, depicting a web browser containing a Flash banner as the user interacts with the banner.

FIG. 3 is an outline of the steps taken in a method according to one embodiment of the invention.

### DETAILED DESCRIPTION OF THE INVENTION

Although the following discussion are directed mostly to real estate property listings, it would be clear to a person in the art that any classified and inventory-based listings such as for cars/autos, jobs/recruitment, personals and travel are within the scope of this invention.

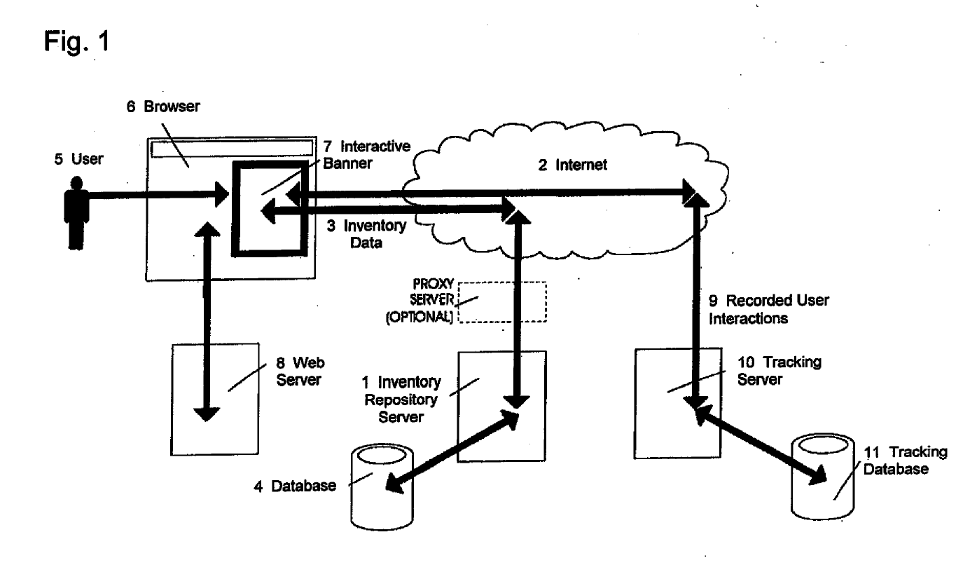

With reference to FIG. 1, according to one embodiment of this invention, a customized inventory repository server 1 is connected to an information network (such as the Internet) 2, accepting inventory data 3 from an advertiser via a real-time feed or data input device. The technology provides for a unique method of displaying multimedia content, including graphics, photographs, and textual descriptions of each listing, as well as branding information for agents and brokers. It simplifies and expedites the process of producing online listing ads and is able to generate more web exposure (impressions) than traditional banner ads.

The inventory data 3 may contain a plurality of text data, numeric data, images, multiple URLs, rich media (including, but not limited to, creative artwork, streaming banners, video, and audio clips), as well as directives on how, where, and when the inventory data is to be presented on a rich media advertisement. Each listing includes a data record set describing property listing information organized according to individual real estate agent. The data record set contains all information such as ad display duration time, publisher selection, campaign ID, campaign duration, listing(s) details.

Prior to inventory data 3 being rendered for display on the Internet on a web page, it may undergo a conditionally, multi-step approval process, which is a workflow allowing advertisers and administrators to verify data integrity and appropriateness. If inventory data is being fed from a trusted source, the approval process can be waived for immediate release on rich media advertisements.

Flash banner 7 is served by the ad server 8 to a user 5 running a browser 6 displaying a web page on the information network. Running on each browser 6 that renders inventory data 3 in a rich media advertisement is a customized software component called the controller, which retrieves inventory data 3 and customized rendering instructions, interpolates this data into an advertisement or Flash banner 7, and records and acts upon user interactions (render counts, mouse and keyboard activity). Inventory data 3 is formatted and displayed within the Flash banner 7, one item at a time, using various graphical transitioning techniques.

An inventory repository server 1 is connected to the information network 2. It receives requests from the controller for inventory data 3 and rendering instructions, and streams the data back via standard protocols. Inventory is selected from the inventory repository server 1 according to advertisement placement, targeting campaigns, pre-defined randomization and/or weighting rules.

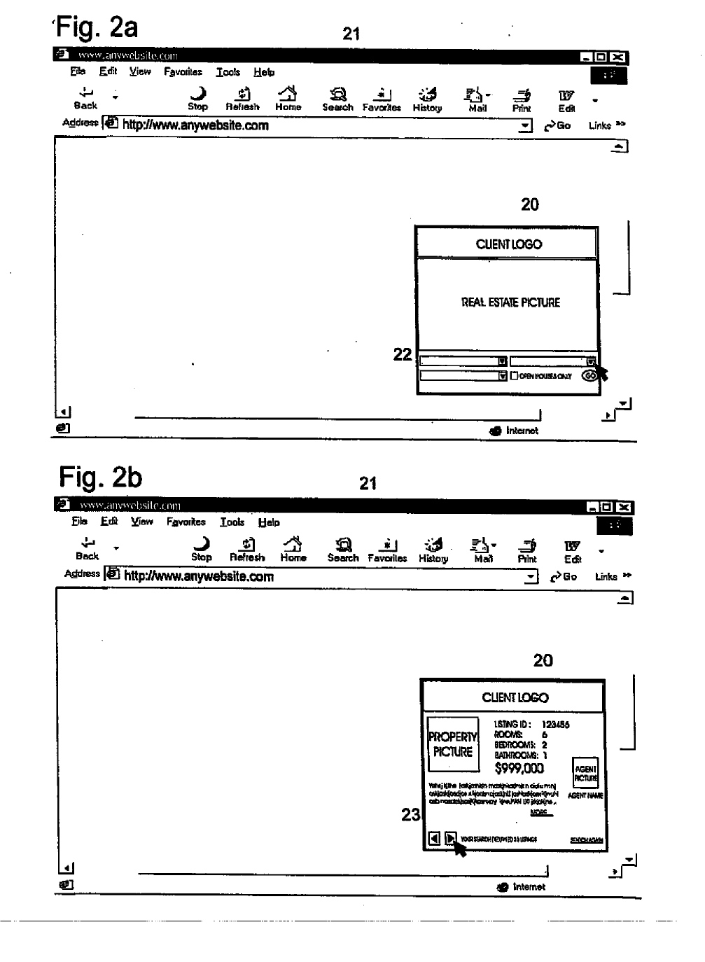

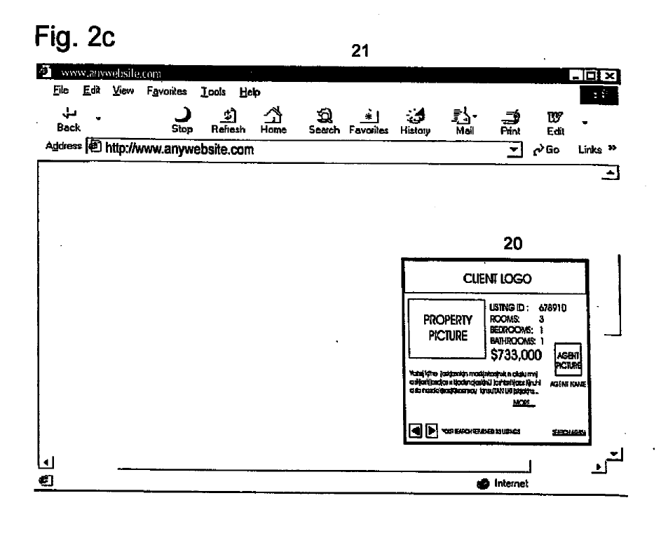

With reference to FIGS. 2a, 2b, and 2c, a preferred embodiment of this invention displays multiple listings within a Flash banner 20 in a browser 21, displaying a web page. The controller embedded within the browser 21 receives user input 22, as shown in FIG. 2a. The inventory data is returned, and displayed within the banner 20 as shown in FIG. 2b. Inventory data may be formatted and displayed, one item at a time, using various graphical transitioning techniques, as shown in FIG. 2c.

With further reference to FIG. 1, the components of the preferred embodiment include a database 4 and an inventory repository server 1 accepting listing updates on a real time basis, a client campaign management tool, a system administrator module, an ad server 8, and a Flash banner 7 that drives the display of multiple listings that is embedded in a webpage.

Listings can either be entered into the system by each agent using a controlled secure web interface, or in bulk fashion by processing uploads from a broker. As mentioned earlier, listings may move through a workflow to verify correctness, ensure that the content and photos are appropriate, and for final approval.

Unlike existing ad services, a person entering listing information need only provide listing descriptions and photos and not have to worry about artistic content. As a result, production costs are greatly reduced.

Listings are grouped together in “campaigns”, and campaigns are targeted for display on one or more web properties. Each campaign may have custom Flash creative content that further enhances the visual effects of an advertising banner.

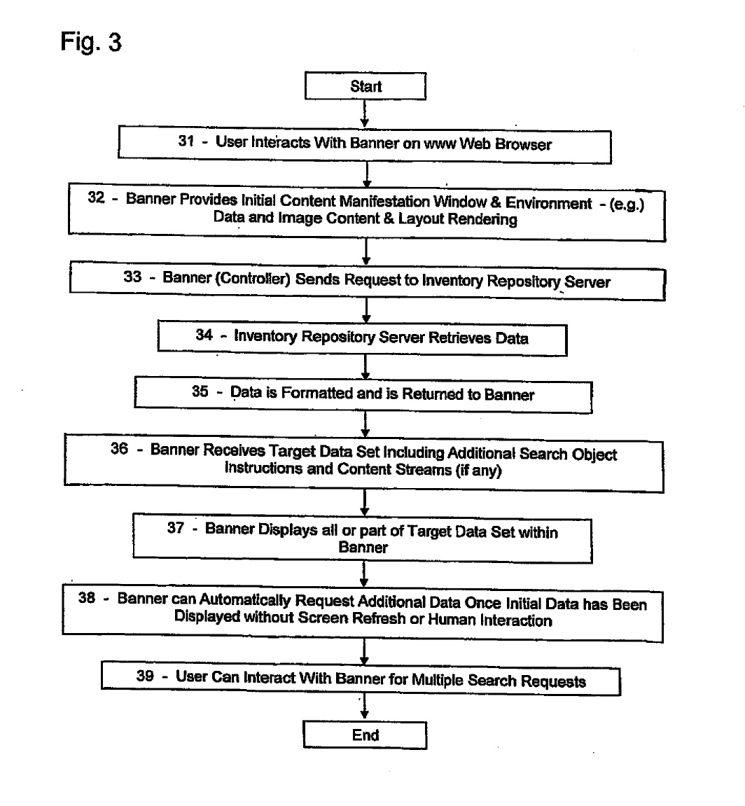

With reference to FIG. 3, when the ad server 8 receives a request 33 from an embedded banner according to this invention, the inventory repository server selects 34 all relevant customer campaigns, retrieves all listings, and generates an XML string, containing information on what listings to render and in what formats. A target data set in a data string describing one or more such listing(s) for at least one such agent is compiled 35 by the central database upon initiation of a session. The listing(s) matching the target data set from the database are identified and then retrieved 36 by the controller enabled with dynamic messaging technology and displayed 37 on one or more Flash banner(s), residing on one or more publisher web sites. It dynamically transmits the listing(s), in near or real time, to the requester.

By default, all listings have equal exposure on the targeted web properties, although listings can be weighted for more or less exposure on various web properties.

Owners of listings are able to check the exposure (impressions) that a listing has had, as well as determine how many users “click-thru” the ad to get more listing details at a pre-specified web address.

The central database is able to serve (approved) new and updated listings to the Ad Server for immediate display on targeted web properties.

The scope of the claims that follow is not limited by the embodiments set forth in the description. The claims should be given the broadest purposive construction consistent with the description as a whole.

What is claimed is:

1. A system for dynamic display of real estate data in a browser on an electronic network, comprising:
an inventory repository server containing inventory data, the inventory data comprising a plurality of listings;
a web page with at least one Flash banner rendered by a controller and enabled with dynamic messaging technology, the controller in electronic communication with the inventory repository server through the electronic network, the controller for receiving user input from a user, and inventory data from the inventory repository server;
wherein a target data set, the target data set being a subset of the inventory data, is compiled by the inventory repository server in a data string comprising one or more such listings and customized rendering instructions; the data string being retrieved by the controller in response to a request from the user, the target data set being displayed by the controller within the at least one Flash banner in accordance with the customized rendering instructions.

2. The system of claim 1, wherein each of the listings comprises a data record set describing property listing information organized according to individual real estate agent, the data record set containing all information comprising ad display duration time, publisher selection, campaign ID, campaign duration, and listing details.

3. The system of claim 1, further comprising a client campaign management tool and a system administrator module.

4. The system of claim 1, wherein the target data set comprises plural text data, numeric data, and at least one image, and the customized rendering instructions comprise directives on how and where the target data set is to be presented within the Flash banner.

5. The system of claim 1, wherein the target data set comprises plural text data, numeric data, and at least one video clip and/or audio clip.

6. The system of claim 4, wherein the target data set further comprises multiple URLs.

7. The system of claim 1, wherein the request from the user is a search request comprising a request to interface with the inventory data in a dynamic search session.

8. The system of claim 7, wherein the request at least partially comprises keyboard input.

9. A method for dynamic display of real estate data in a browser on an electronic network, comprising the steps of:
receiving a request at an inventory repository server from a user through a controller embedded within a browser;
compiling at the inventory repository server a target data set for real estate data in a data string comprising one or more listings for at least one agent, and customized rendering instructions, wherein the inventory repository server is in electronic communication with a database storing real estate data and the controller;
retrieving the target data set from the inventory repository server by the controller; and
displaying the real estate data within a banner residing on a web page, wherein the banner is rendered by the controller in accordance with the customized rendering instructions, wherein the request is generated using mouse and keyboard input from the user.

10. The method of claim 9, wherein each of the listings comprises a data record set describing property listing information organized according to individual real estate agent, the data record set containing all information comprising ad display duration time, publisher selection, campaign ID, campaign duration, and listing details.

11. The method of claim 9, wherein the target data set comprises plural text data, numeric data, and at least one image, and the customized rendering instructions comprise directives on how and where the target data set is to be presented within the banner.

12. The method of claim 9, wherein the wherein the target data set comprises plural text data, numeric data, and at least one video clip and/or audio clip, and the customized rendering instructions comprise directives on how, where, and when the inventory data is to be presented within the banner.

13. The method of claim 9, wherein the wherein the target data set further comprises multiple URLs.

14. The method of claim 9, wherein the request from the user is a search request comprising a request to interface with the inventory data in a dynamic search session.

15. The method of claim 14, wherein the request at least partially comprises keyboard input.

16. A system for dynamic display of inventory data on a web page displayed within a browser, comprising:
an inventory repository server comprising inventory data, the inventory data comprising a number of items;
an ad server;
a web page with at least one Flash banner rendered by a controller and enabled with dynamic messaging technology, the controller, the ad server and the inventory repository server in electronic communication with each other;
wherein the controller receives user input from a user, and requests a target data set from the ad server, the target data set being a subset of the inventory data, based on the user input;
wherein the target data set is compiled in a data string by the inventory repository server, the data string comprising one or more items and customized rendering instructions;
wherein the data string is retrieved by the ad server, and displayed within the banner to the user in accordance with the customized rendering instructions.

17. The system of claim 16, wherein the display of the target data set to the user is displayed one item at a time within the at least one banner.

18. The system of claim 16, wherein the user input comprises a request to interface with the inventory data in a dynamic search session.

19. The system of claim 18, wherein the at least one banner provides for controls for the user to conduct multiple commands to search on the basis of differing user input, and upon receiving multiple requests to search, the banner retrieves target data sets according to the differing user input.

20. The system of claim 16, wherein the target data set is updated for immediate display by the controller.

21. The system of claim 16, wherein the target data set comprises plural text data, numeric data, and at least one image, and the customized rendering instructions comprise directives on how and where the target data set is to be presented within the banner.

22. The system of claim 16, wherein the target data set comprises plural text data, numeric data, and at least one video clip, and the customized rendering instructions comprise directives on how, where, and when the target data set is to be presented within the banner.

23. The system of claim 21, wherein the target data set further comprises multiple URLs.
